(19) United States
(12) Patent Application Publication
(10) Pub. No.: US 2007/0217962 A1
(43) Pub. Date: Sep. 20, 2007

(54) Packaging of Pre-Measured Chemicals for Scholastic Purposes

(76) Inventor: David Lawrence deLesdernier, Kennett Square, PA (US)

Correspondence Address: David L. deLesdernier, 911 Mitchell Farm Lane, Kennett Square, PA, 19348, US

(21) Appl. No.: 11/680,112

(22) Filed: Feb. 28, 2007

Related U.S. Application Data
(60) Provisional application No. 60/767,061, filed on Mar. 1, 2006.

(51) Int. Cl. B01J 19/00

(52) U.S. Cl. 422/129

(57) ABSTRACT

This system simplifies the shipping and handling requirements, reduces the quantity of chemicals stored at the school, enables the labs to be taught by less skilled individuals and provides a convenient method for proper disposal of any resulting chemical wastes. Specifically, by having pre-measured, small quantity of components in containers sized for final use, the cost of handling required for shipping and storage are minimized while assuring the final concentration of solution is accurate for the intended experiments. It also reduces the skill of the individual making the final solution. The disposal issue is addressed by having little or no excess starting chemicals and by the packaging of the kits.

The present application claims benefit of U.S. Provisional Application Ser. No. 60/767,061, filed on Mar. 1, 2006 the priority of which is claimed.

### BACKGROUND (DESCRIPTION OF THE STATE OF THE ART)

Current packaging of materials and chemicals in particular are designed for either bulk, diluted or concentrated forms. In the case where they are for concentrated materials they are designed for either consumer or industrial applications and not for scholastic purposes. Educational uses of chemicals for laboratory experiments now require specialized training that many schools and/or teachers do not have. This training includes the safe handling and disposal of chemicals many of which are hazardous as defined by local, state and federal regulations. As a result many science classes have restricted the use of laboratory experiments which has reduced the effectiveness of the instruction. The system described below addresses these issues and allows schools and teachers with less training to perform laboratory experiments safely and in accordance with applicable regulations.

### SUMMARY

Prior and current practices for conducting laboratory experiments involving chemicals at many schools (primary, secondary, and post secondary) include the receipt and storage of bulk chemicals with subsequent measuring by weight or volume and/or mixing with additional chemicals to produce the correct quantity/concentration for the students to use. This activity is done by a skilled teacher/instructor, typically a degreed chemist or biologist. Once the experiment is completed, contaminated materials may exist that have to be properly disposed of according to regulatory requirements. These factors (shipping and receiving hazardous chemicals, storage of bulk chemicals, mixing and/or blending chemicals and proper disposal of HAZMAT wastes) are restricting schools from providing hands-on laboratory experiments for science courses.

This system simplifies the shipping and handling requirements, reduces the quantity of chemicals stored at the school, enables the labs to be taught by less skilled individuals and provides a convenient method for proper disposal of any resulting chemical wastes. Specifically, by having pre-measured, small quantity of components in containers sized for final use, the cost of handling required for shipping and storage are minimized while assuring the final concentration of solution is accurate for the intended experiments. It also reduces the skill of the individual making the final solution. The disposal issue is addressed by having little or no excess starting chemicals and by the packaging of the kits.

For many solutions a small quantity of higher concentration requires simpler handling than a larger quantity of the same but more dilute solution. This also holds for a small quantity of solid (e.g. grams) versus a larger quantity of solution (e.g. 100's of grams). This invention allows less skilled teacher/instructor who may not be skilled in the art of chemical preparation to facilitate a broader range of experiments thereby enhancing the learning process in a safe manner. In addition, it simplifies the handling requirements by allowing less restrictive transport of chemicals.

### DESCRIPTION OF THE DRAWING

FIG. 1 depicts the system which consists of a quantity of chemical or chemicals (2) in a container (1) sized for the addition of other chemical or chemicals. The correct quantity to add may be either noted on the label (5) or on the container itself as an annotated fill line (6). Multiple fill lines may be used if more than one chemical is to be added with each line denoted with the appropriate compound. In cases where the sequence of addition is important this will also be noted. The label will describe the contents for both before and after mixing. For bottles the opening will have a curved lip (4) to minimize dripping/spillage when pouring the contents. The cap (3) design will be child resistant.

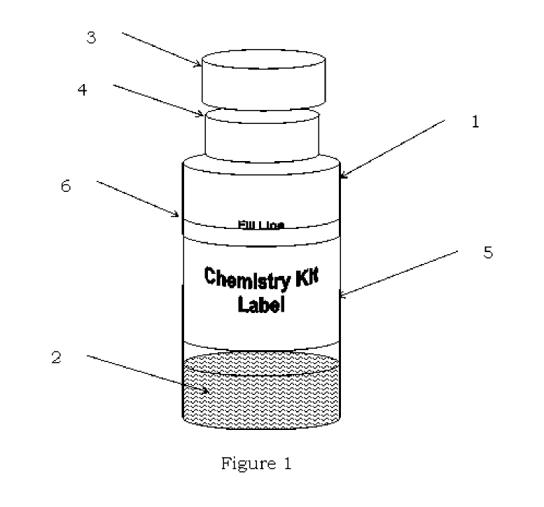

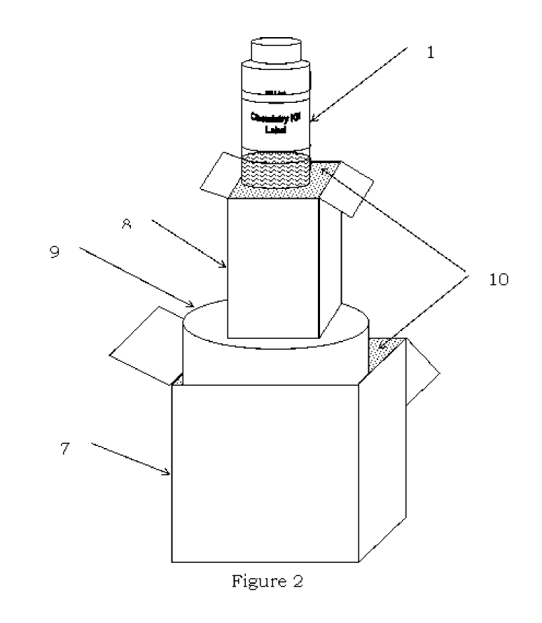

This container (bottle) may be packaged in a shipping container, FIG. 2, (7) that is sized to contain the resulting wastes from the experiments. The container will have a liner (9) which may be integral with the exterior container or separate as in a leak resistant bag and a closure mechanism such as a twist tie. If warranted the container will include adsorbent (10) material to contain any leaks. For photosensitive materials/compounds, an opaque, light tight container (8) for the bottle will be included.

### DETAILED DESCRIPTION OF THE PREFERRED EMBODIMENT

The system consists of a pre-measured quantity of chemical or chemicals in a container of sufficient size to receive additional chemicals, thereby creating the desired compound, compounds or solution for use by a teacher or instructor in primary, secondary or post secondary educational environment. One embodiment of this system would be 5.1 grams of solid silver nitrate in a 300 mL bottle which upon adding 300 mL of water would give a 0.1 M solution of silver nitrate for use in chemistry laboratory experiments. Photo sensitive materials such as silver nitrate would be packaged in an additional opaque container (for example, cardboard box) for storage to extend shelf life.

An additional aspect of this invention is the bulk packaging is sized to hold any contaminated solid waste created from the experiment. An example is the lead iodide experiment which is safely conducted in a primary or secondary school environment but creates solid waste contaminated with lead compounds. To aid in regulatory compliance, the shipping containers are oversized with appropriate liners to safely repackage, ship and dispose of the contents.

What is claimed is:

1. A system consisting of a container with a pre-measured amount of liquid or solid chemical in a closed container sized to contain the volume once additional liquid or solid chemical or chemicals are added.

2. A system as in 1 with a child proof safety cap.

3. A system as in 1 where the additional chemical is water which produces the correct concentration of the first chemical once the water is added.

4. A system as in 3 where the final solution is ready for use in experiments by primary, secondary or post secondary courses.

5. A system as in 4 where the final solution is part of an approved, integrated course.

6. A system as in 3 where the final solution is ready for use in experiments by home schooled students in approved course work.

7. A system as in 4 where the courses are in a science curriculum.

8. A system as in 6 where the courses are in a science curriculum.

9. A system as in 1 where the labeling of the container correctly describes the contents for both the initial and the final forms.

10. A system as in 1 where the separation of the initial and the subsequent chemicals reduces the hazardous materials shipping requirements.

11. A system as in 10 where the hazardous materials shipping requirements are reduced to commodity status allowing unrestricted shipping.

12. A system as in 1 where the container is marked with the correct fill volume for each of the additional chemicals.

13. A system as in 12 where the marking of the additional chemicals are in a specified sequence as required for the safe handling or to insure proper reaction sequence.

14. A system as in 1 with drip proof lip to aid in pouring the contents into other containers.

15. A system of exterior and interior packaging that is sized for subsequent use as a disposal container of hazardous wastes resulting from experiments utilizing the initial contents of the package.

16. A system as in 14 where the container contains an absorbent material to contain any leakage of the internal containers.

17. A system as in 14 where the containers are nested in light tight containers to prolong the shelf life of photo sensitive chemicals.
